(19) United States
(12) Patent Application Publication
(10) Pub. No.: US 2025/0179697 A1
(43) Pub. Date: Jun. 5, 2025

(54) STRUCTURAL COMPOSITES WITH EMBEDDED LIGHTING

(71) Applicants: Composites Intellectual Holdings, Inc., Melbourne, FL (US); Guardtex SAS, Sarzeau (FR)

(72) Inventors: Scott M. Lewit, Indialantic, FL (US); Thierry Plagué, Sarzeau (FR)

(21) Appl. No.: 19/042,768

(22) Filed: Jan. 31, 2025

Related U.S. Application Data
(63) Continuation of application No. PCT/US23/29120, filed on Jul. 31, 2023.
(60) Provisional application No. 63/393,967, filed on Jul. 31, 2022.

(51) Int. Cl. D03D 15/547; B63B 45/00; D06M 15/572; F21V 31/00

(52) U.S. Cl. CPC D03D 15/547; B63B 45/00; D06M 15/572; F21V 31/005; F21V 2200/15

(57) ABSTRACT

A lighting apparatus and system, comprising optical fibers attached to a textile layer; the textile layer and the at least one optical fiber covered by a resin, which may be a co-cure resin, that has been cured, forming a fiber-resin boundary. The at least one optical fiber is attachable to a source of light energy so as to be in optical communication with the source of light energy, such that light energy from the source of light energy is communicated to optical fibers and propagates along the optical fibers when the source of light energy is activated. An index of refraction of the cured resin is related to an index of refraction of the optical fibers such that a desired portion of the light energy propagating along the optical fiber escapes the optical fibers when it encounters the fiber-resin boundary and is observable from outside the composite structure.

### CROSS REFERENCE TO RELATED APPLICATIONS AND INCORPORATION BY REFERENCE

This application for patent is a continuation of and claims benefit of priority to International Application No. PCT/US23/29120 entitled STRUCTURAL COMPOSITES WITH EMBEDDED LIGHTING, filed in the United States Receiving Office (USRO) on Jul. 31, 2023, which is hereby incorporated by reference herein in its entirety; International Application No. PCT/US23/29120 claims benefit of priority to U.S. Provisional Patent Application No. 63/393,967 entitled “STRUCTURAL COMPOSITES WITH EMBEDDED LIGHTING”, filed in the United States Patent and Trademark Office (USPTO) on Jul. 31, 2022 which is incorporated by reference herein in its entirety. This application also makes reference to certain co-cured resin material compositions, and processes and methods for making such material compositions, that are disclosed in the following U.S. patent applications and issued patents: U.S. Pat. No. 9,371,468 CO-CURED GEL COATS, ELASTOMERIC COATINGS, STRUCTURAL LAYERS, AND IN-MOLD PROCESSES FOR THEIR USE that issued from the United States Patent and Trademark Office (USPTO) on Jun. 21, 2016 (“the '468 patent”); U.S. Pat. No. 10,513,100 entitled CO-CURED GEL COATS, ELASTOMERIC COATINGS, STRUCTURAL LAYERS, AND IN-MOLD PROCESSES FOR THEIR USE, which issued from the USPTO on Dec. 24, 2019 (“the 100 patent”); U.S. Pat. No. 10,596,791, entitled COCURED GEL COATS, ELASTOMERIC COATINGS, STRUCTURAL LAYERS, AND IN-MOLD PROCESSES FOR THEIR USE that issued from the USPTO on Mar. 24, 2020 (“the '791 patent”); and U.S. patent application Ser. No. 16/824,322, entitled CO-CURED GEL COATS, ELASTOMERIC COATINGS, STRUCTURAL LAYERS, AND IN-MOLD PROCESSES FOR THEIR USE, filed in the USPTO on Mar. 19, 2020, which published as U.S. Patent Publication No. US 2020-0215806 A1 on Jul. 9, 2020 (“the '322 application); the entire disclosure of each of the foregoing U.S. patents and U.S. patent publications is incorporated herein by reference.

This application also makes reference to U.S. patent application Ser. No. 16/611,119, entitled FLEXIBLE COVERING ITEM, which published from the USPTO on Jun. 18, 2020 as U.S. Patent Publication No. US 2020/0189696 A1, which issued from the USPTO as U.S. Pat. No. 10,875,611 on Dec. 29, 2020 (“the '611 patent”), the entire disclosure of which is incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to lighting apparatuses, devices, systems and methods in which light that is generated from a source of light energy is transmitted along one or more optical fibers to provide lighting to an area. The one or more fiber-optic elements may provide a path for transmitting light energy along a longitudinal axis of the optical fibers to a desired area without use of additional electronics or electrical conductors, allowing use of the invention in wet or corrosive environments. The field of the invention further relates to the use of fiber-optic elements to provide lighting to an area by causing light energy to escape the optical fibers in a direction transverse to the longitudinal axis of the optical fiber by use of a resin, which may be, but is not necessarily, a co-cure resin, or other material of appropriate index of refraction, such that a portion of the light energy propagating through the optical fiber escapes the optical fiber(s) in a transverse direction as the light energy propagates along the length of the optical fibers.

### 2. Background Art

It has long been desired to provide lighting to certain spaces, surfaces, areas, etc. in certain areas that are hostile to electronic or electric lighting devices of the prior art. Such areas may include areas located in corrosive, wet, or hard-to-reach environments. In such areas, water, salts or other corrosive substances that cash corrosion and degradation of electric or electronic lighting components and wiring may be present in the environment. Thus, it has long been desired to eliminate problems arising from the use of electrically conductive materials, such as metal wire, connectors, semiconductors, and electrical and electronic components, in, for example, salt-air environments such as marine environments, due the corrosive nature of such environments. It is also often desirable in some lighting use cases, such as in boats, that the composite structures forming the boat provide accommodation for lighting of various kinds so as to provide a desired lighting effect which may provide lighting for safety reasons, decorative reasons, or any other reason. However, embedding active electrical or electronic components in a composite structure is problematic due to electric or electronic component overheating concerns, maintenance and repair concerns, and other concerns.

Currently, the only available option for lighting a composite structure is to embed lighting strips containing active electronic lighting elements, such as light emitting diodes (LEDs) or other lighting elements, that dissipate electrical energy the form of heat, and require drilling, machining or molding openings in the composite structure, possible causing a weakening of the overall structure. The use of active lighting components also results in elevated temperatures of the lighting elements due to the fact that the thermal transfer characteristics of the surrounding composite structure generally exhibits low thermal conductivity, causing elevated or runaway temperature at the active devices, resulting in failure or reduced lifetime of the active lighting devices.

Still further, environments that are subject to explosion in the presence of electric currents are especially problematic when it comes to lighting. Traditionally, great expense may be incurred in the providing of sealed transparent windows or other structures for isolating active lighting elements from an explosive environment, due to the risk of electric current arcing, and igniting the explosive atmosphere. It would be a great improvement in the art to provide lighting in such environments that does not require or use any electric current. One non-limiting example of such need for lighting in explosive atmospheres is the lighting of the internal volume of fuel tanks in order to inspect the tanks, determine fuel level or quality, etc.

### BRIEF SUMMARY OF THE INVENTION

The invention comprises one or more of the following features, elements or method steps, in any combination, quantity or order.

The apparatus, system and methods of the invention overcome the aforementioned problems associated with prior art by enabling the use of solely nonconductive materials embedded in a structure, such as a composite structure, that require no maintenance over their lifetime, do not contain electrical or electronic components or require electric current at the lighting apparatus location, provide desired safety, decorative or other lighting, are embedded in the composite structure such that they are protected from environmental elements, are noncorrosive due to use of non-electrically conductive materials, do not conduct electric current during operation and thus are not an explosion hazard, and are able to provide desired lighting to an area in the proximity of the composite structure. The apparatus and system of the invention may be molded directly into a composite structure at time of manufacture, and may be essentially maintenance-free over the life of the structure. In embodiments, a composition of resin, such as a co-cure resin, used to produce a lighting apparatus of the invention is especially adapted to facilitate uniform and even lighting across the dimensions of a lighting apparatus of the invention. The lighting apparatuses, systems and methods of the invention are adaptable to composite structures and applicable for use in virtually any application. While a boat hull application may be described herein and shown in the figures, this is just one non-limiting, exemplary application and use of the apparatus, system and method of the invention. No electric current or power is communicated to or used by the lighting apparatus and system of the invention, so it dissipates no electrical power in the composite structure while in use and is thus not subject to the thermal runaway and structural problems experienced by prior art lighting technology. In embodiments, the lighting apparatus may contain no electrically conductive materials at the lighting site. Although the light source 201 may comprise electrical, electronic and electrically conductive materials, it may be located remotely from the lighting site, and may transmit light energy to the lighting apparatus via electrically non-conducting optically transmissive fiber optic cables.

The system, apparatus and method of the invention is applicable to any structural composite manufacturing processes including, but not limited to, casting, compression molding, hand lay-up, spray-up, resin transfer molding (RTM) and light RTM, and vacuum infusion. The system, apparatus and method of the invention is applicable to any laminated product or process of making a laminated product. Further, the system, apparatus and method of the invention is applicable to be used in, for example and not by way of limitation; products in the marine, recreational vehicle, outdoor, safety, rail transportation, pools and spas, aircraft, spacecraft, explosive atmospheres, underwater, waterproof, energy, automotive, architectural and other markets. Non-limiting, exemplary products include but are not limited to lighted signage, logo lighting in a boat, recreational vehicle, auto, or other products and/or structures; pillars; boat bait well lighting; bilge lighting; safety jackets; safety gear and equipment; trailer lighting; fuel tank and other explosive environment lighting; stairs and stairwell lighting; marine, truck, and auto interior lighting; theme park ride lighting; head lighting; external lighting; pools and related structures; spas; lighting for any enclosed space and any other structure which is desired to be lighted.

The lighting system, apparatus and method of the invention overcomes the shortcomings of the prior art in that it does not require electric current to be communicated to the lighting apparatus, meaning that may be used in explosive environments such as, for example and not by way of limitation, fuel tanks, tanks containing any explosive or flammable media, or any other explosive or flammable environment.

In embodiments that comprise co-cure resin, the lighting system and apparatus benefit from the increased toughness of the cured co-cure resin as compared with traditional epoxy resins.

In embodiments, the invention comprises a lighting apparatus and system, comprising at least one optical fiber having a length and a longitudinal axis, and an outer surface; wherein the at least one optical fiber is attached to a textile layer; wherein the textile layer and the at least one optical fiber are covered by a resin, such as a co-cure resin, that has been cured, wherein the cured resin is in contact with at least a portion of the outer surface of the at least one optical fiber, which may be the outer surface of optical fiber 100 cladding, forming a fiber-resin boundary, for at least a portion of the length of the optical fiber; wherein the at least one optical fiber is attachable to a source of light energy so as to be in optical communication with the source of light energy, such that light energy from the source of light energy is communicated to and received by the at least one optical fiber and propagates along the at least one optical fiber when the source of light energy is activated; wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the composite structure; while the remainder of the energy propagating along the at least one optical fiber is reflected back into the optical fiber and continues to propagate along the fiber until it again encounters the fiber-resin boundary.

In embodiments, the at least one optical fiber may further be defined as a plurality of optical fibers, each having an elongate shape having a longitudinal axis, each longitudinal axis of each of the optical fibers running in the same direction.

In embodiments, the optical fibers of the plurality of optical fibers may run in the same direction and are arranged to form a linear array when viewed in a cross-section taken transverse to the longitudinal axis of the plurality of optical fibers.

In embodiments the resin comprises, or is, a co-cure resin; and further in embodiments the co-cure resin may comprise a urethane component in a range of 25%-35% by weight.

In embodiments the at least one optical fiber may be attached to the textile layer by weaving, using a binding thread, forming a woven illuminating layer.

In embodiments, the intensity of the desired light energy escaping from the fiber-resin boundary may be uniform, or substantially uniform, along the length of the lighting apparatus.

In embodiments, the cured resin, which may be, but is not necessarily a co-cure resin, may remain tacky after curing, facilitating placement of the lighting apparatus in the laminating lay-up steps of a molding process of a composite structure.

In embodiments, the invention comprises a lighted composite structure, comprising: a composite structure; at least one optical fiber having a length and a longitudinal axis, and an outer surface; wherein the at least one optical fiber is attached to a textile layer; wherein textile layer and the at least one optical fiber are covered and saturated by a resin, which may be a co-cure resin, that has been cured, forming a lighting apparatus wherein the cured resin is in contact with at least a portion of the outer surface of the at least one optical fiber, forming a fiber-resin boundary, for at least a portion of the length of the optical fiber; wherein the at least one optical fiber is attachable on one of its ends to a source of light energy so as to be in optical communication with the source of light energy, such that light energy from the source of light energy is communicated to and received by the at least one optical fiber and propagates along the at least one optical fiber when the source of light energy is activated; wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the composite structure; while the remainder of the energy propagating along the at least one optical fiber is reflected back into the optical fiber and continues to propagate along the fiber until it again encounters the fiber-resin boundary; and wherein the lighting apparatus is disposed in the composite structure in proximity to an outer surface of the composite structures such at the light energy escaping the fiber-resin boundary of the light-emitting side of the lighting apparatus is observable from outside the composite structure outer surface.

In embodiments, the at least one optical fiber may further be defined as a plurality of optical fibers, each having an elongate shape having a longitudinal axis, each longitudinal axis of each of the optical fibers running in the same direction.

In embodiments, the optical fibers of the plurality of optical fibers may run in the same direction and may be arranged to form a linear array when viewed in a cross-section taken transverse to the longitudinal axis of the plurality of optical fibers.

In embodiments the resin comprises a co-cure resin; and further in embodiments the co-cure resin may comprise a urethane component in a range of 25%-35% by weight.

In embodiments, the at least one optical fiber is attached to the textile layer by weaving, using a binding thread, forming a woven illuminating layer.

In embodiments, the intensity of the desired light energy escaping from the fiber-resin boundary is uniform or substantially uniform along the length of the lighting element.

In embodiments, the composite structure is further defined as a laminated composite structure, produced using a mold.

In embodiments, the cured co-cure resin remains tacky after curing, facilitating placement of the lighting apparatus in the laminating lay-up steps of a molding process.

In embodiments, the composite structure forms a portion of a boat hull or any other object body structure.

In embodiments, the invention comprises a method for producing a lighting apparatus, comprising the steps of: providing a smooth molding surface; applying a layer of clear gel coat to the smooth molding surface; applying a first layer of resin, which may be a co-cure resin, to the clear gel coat; applying a lighted fabric to the layer of resin, the lighted fabric having a light emitting side, the light emitting side oriented against the first layer of co-cure resin; applying a second layer of resin, which may be a co-cure resin, to the non-light emitting side of the lighted fabric; applying a layer of white gel coat to the second layer of co-cure resin to form a background layer; and curing the first and second layers of resin; wherein the lighted fabric comprises: at least one optical fiber having a length and a longitudinal axis, and an outer surface; wherein the at least one optical fiber is attached to a textile layer; wherein the textile layer and the at least one optical fiber are saturated by first and second layers of resin prior to curing, and wherein the first and second layers cured resin is in contact with at least a portion of the outer surface of the at least one optical fiber, forming a fiber-resin boundary, for at least a portion of the length of the optical fiber; wherein the at least one optical fiber is attachable to a source of light energy so as to be in optical communication with the source of light energy, such that light energy from the source of light energy is communicated to and received by the at least one optical fiber and propagates along the at least one optical fiber when the source of light energy is activated; and wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the lighting apparatus; while the remainder of the energy propagating along the at least one optical fiber is reflected back into the optical fiber and continues to propagate along the fiber until it again encounters the fiber-resin boundary.

In embodiments, the at least one optical fiber is further defined as a plurality of optical fibers, each having an elongate shape having a longitudinal axis, each longitudinal axis of each of the optical fibers running in the same direction.

In embodiments, the optical fibers of the plurality of optical fibers run in the same direction and are arranged to form a linear array when viewed in a cross-section taken transverse to the longitudinal axis of the plurality of optical fibers.

In embodiments the resin comprises a co-cure resin; and further in embodiments the co-cure resin may comprise a urethane component in a range of 25%-35% by weight.

In embodiments, the at least one optical fiber is attached to the textile layer by weaving, using a binding thread, forming a woven illuminating layer.

In embodiments, the intensity of the desired light energy escaping from the fiber-resin boundary is uniform, or substantially uniform, along the length of the optical fiber.

In embodiments, the cured resin remains tacky after curing, facilitating placement of the lighting apparatus in the laminating lay-up steps of a molding process.

In embodiments, the invention comprises a method for producing a lighted composite structure, comprising: providing a smooth molding surface for molding a desired surface of a composite structure; applying a layer of clear gel coat to the smooth molding surface; applying a first layer of resin, which may be a co-cure resin, to the clear gel coat; applying a lighted fabric to the layer of resin, the lighted fabric having a light emitting side, the light emitting side oriented against the first layer of resin; applying a second layer of resin, which may be a co-cure resin, to the non-light emitting side of the lighted fabric; applying one or more alternating fabric-resin layers to achieve a desired structural composite structure; and curing the layers of resin; wherein the lighted fabric comprises: at least one optical fiber having a length and a longitudinal axis, and an outer surface; wherein the at least one optical fiber is attached to a textile layer; wherein the textile layer and the at least one optical fiber are saturated by the first and second layers of resin prior to curing, and wherein the first and second layer cured resin is in contact with at least a portion of the outer surface of the at least one optical fiber, forming a fiber-resin boundary, for at least a portion of the length of the optical fiber; wherein the at least one optical fiber is attachable to a source of light energy so as to be in optical communication with the source of light energy, such that light energy from the source of light energy is communicated to and received by the at least one optical fiber and propagates along the at least one optical fiber when the source of light energy is activated; and wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the composite structure; while the remainder of the energy propagating along the at least one optical fiber is reflected back into the optical fiber and continues to propagate along the fiber until it again encounters the fiber-resin boundary.

In embodiments, the at least one optical fiber is further defined as a plurality of optical fibers, each having an elongate shape having a longitudinal axis, each longitudinal axis of each of the optical fibers running in the same, or substantially the same, direction.

In embodiments, the optical fibers of the plurality of optical fibers run in the same direction and are arranged to form a linear array when viewed in a cross-section taken transverse to the longitudinal axis of the plurality of optical fibers.

In embodiments the resin comprises a co-cure resin; and further in embodiments the co-cure resin may comprise a urethane component in a range of 25%-35% by weight.

In embodiments, the at least one optical fiber may be attached to the textile layer by weaving, using a binding thread, forming a woven illuminating layer.

In embodiments, the intensity of the desired light energy escaping from the fiber-resin boundary is uniform, or substantially uniform, along the length of the optical fiber.

In any of the embodiments, the optical fibers may be in optical communication with a light source via a system of interconnecting optically transmissive optical fibers.

While specific layup sequences for producing a laminated structure comprising a lighting apparatus of the invention may be described herein, these are merely non-limiting and exemplary in nature. Any number of layers, comprising any materials (i.e. fabrics, resins, gel coats, and other materials) may comprise a lighted structure of the invention.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention. In the drawings:

FIG. 1 depicts a front view of an embodiment of a connectorized lighting apparatus of the invention having a length L. In FIG. 1, the resin coating 101 is shown broken away in several places in order to more clearly show the optical fibers.

FIG. 2 depicts an end view of an embodiment of a lighting apparatus of the invention.

FIG. 3 depicts a front view of an embodiment of a lighting system comprising a lighting apparatus of the invention.

FIG. 4 depicts a cross section view of a portion of an optical fiber of an embodiment of the invention, showing the boundary between an outer surface, such as an outer diameter, of the optical fiber in contact with the resin that has been cured, the resin in contact with an outer surface of the optical fiber along at least a portion of the length of the optical fiber.

FIG. 5 depicts cross section view of an embodiment of a distal end of the optical fibers of the invention.

FIG. 6 depicts a cross section of an embodiment of an array of optical fiber forming a lighting apparatus of the invention, in which, for the particular non-limiting embodiment shown, the optical fibers form a linear array.

FIG. 7 depicts a front view of an embodiment of the lighting apparatus of the invention in which a plurality of light sources is used to illuminate the receiving end of each optical fiber of a plurality of fiber-optic elements, and wherein each of the plurality of light sources is attached to a controller for generating various timing and color of displayed light from the lighting apparatus.

FIG. 8 depicts a perspective view of an exemplary embodiment of a use of the invention, in which the invention is used to provide lighting to the bow area of a boat. In FIG. 8, a portion of the bow may be comprised of vertical, or substantially vertical, surfaces of the boat seatback and seat structures, wherein one or more lighting apparatuses of the vision are formed into the composite structure forming the seatback and seat structure comprising. The view depicted in FIG. 8 is merely exemplary and is intended to depict one of many applications of the invention.

FIG. 9 depicts a cross section view of an exemplary embodiment of a use of the invention, in which the invention is used to provide lighting to the bow area of a boat. In FIG. 9, a portion of the bow may be comprised of vertical, or substantially vertical, surfaces of the boat seatback and seat structures, wherein one or more lighting apparatuses of the vision are formed into the composite structure forming the seatback and seat structure comprising. The view depicted in FIG. 9 is merely exemplary and is intended to depict one of many applications of the invention.

FIG. 9A depicts a cross section view of a generalized use case of the invention, in which a lighting apparatus is embedded in an object body structure.

FIGS. 10 and 11 depict the use of non-co-cure resins, and show the degradation of light output along length L of lighting apparatus 001; i.e. in these figures, the light output of the lighting apparatus is not uniform or substantially uniform along the length of the lighting apparatus 001 and 002.

FIGS. 12 and 13 depict the use of co-cure resins, and show the resulting desired uniformity of light output along length L of lighting apparatus 001 and 002.

In the drawings, like item callouts refer to like features.

### DETAILED DESCRIPTION OF THE INVENTION

The following documentation provides a detailed description of the invention.

As used herein, “fiber optic element”, “optical fiber” and “diffusing optical fibers” have the same meaning, which includes any structure having a length that is capable of transmitting light energy from a light entry point, in which light energy is launched into the structure such that the light energy propagates along the length of the structure. The optical fiber may be comprised of any material or combination of materials that is at least partially transmissive in the range of wavelength of the light energy that is launched into the optical fiber. Exemplary materials comprising an optical fiber are plastic materials, glass materials, quartz materials and other optically transmissive materials. The structure may be elongate, and may have a longitudinal axis running along the length of the elongate structure; for example, the optical fiber may be in the form of an elongate wire-like structure, having an outer surface and a longitudinal axis. A non-limiting example of an elongate optical fiber having a wire-like structure is an elongate structure of circular or other shape cross section, such as is known in the optical fiber art. All cross sectional shapes of optical fiber are included within the intended scope of the invention. The material or combination of materials comprising the optical fiber may be homogeneous across a cross section of the optical fiber, or they may be non-homogenous in material composition, index of refraction, transmissivity or other material characteristic. The outer surface of an optical fiber may be abraded or otherwise processed to form discontinuities in the outer surface of the optical fiber, in order to facilitate light energy exiting the optical fiber in a direction out of the outer surface, the direction having a component transverse to the longitudinal axis of the optical fiber. In embodiments, the optical fibers may comprise a plastic core fiber having a first refractive index covered with a cladding made of plastic of second, different refractive index, allowing light that is introduced into the optical fiber to be transmitted via internal reflections from the interface between the cladding and the plastic wire. The cladding may be diffusing, for example because it comprises periodic or aperiodic apertures or surface abrasions, in order that the light is able to diffuse radially (i.e., in a direction transverse to the longitudinal axis of the optical fiber) all along the optical fiber (item 100 in the figures). The optical fibers may be selected to diffuse light in the visible domain. In embodiments, optical fibers 100 are plastic wires covered with a cladding made of plastic of different refractive index allowing light that is introduced thereinto to be transmitted via internal reflections from the interface between the cladding and the plastic wire. The diffusing optical fibers may be selected to diffuse light in the visible domain. In an embodiment, the diameter of the optical fiber may be substantially 0.5 mm around the cladding, which may form an exterior surface of the optical fiber. It is not necessary that the optical fibers comprise a cladding.

As used herein, “lighted fabric” includes within its meaning a woven illuminating layer having a textile layer, one or more optical fibers 100, and preferably a plurality of optical fibers 100, running in a direction along the textile layer, and binding threads running in a direction having a component that is transverse to the direction of run of the optical fibers, the binding threads weaving the optical fibers with the textile layer. More generally, a lighted fabric may comprise one or more optical fibers attached to a textile layer. The woven illuminating layer may comprise a border composed of woven textile threads, the diffusing optical fibers extending beyond one edge of the woven illuminating layer, an end segment of the diffusing optical fibers being formed into a strand. The optical fiber strands may be in optical communication with a light source having an optical output for producing light energy output that is optically coupled into the optical fibers forming the strand section, the optical output being connected to the strand of diffusing optical fibers directly or via one or more optically transmissive fibers. When saturated with a resin that may be co-cure resin, the thickness of the cured resin may thin enough to allow the lighted fabric article to be flexible in any direction. “Lighted fabric” may, in embodiments, comprise any lighted fabric article, and any method for making a lighted fabric article, and any element for making a lighted fabric article, in any combination, as described in the '611 patent. A lighted fabric may comprise, for example, a woven illuminating layer comprising diffusing optical fibers and binding threads woven with the diffusing optical fibers to at least one textile layer, the woven illuminating layer furthermore optionally comprising a border composed of woven textile threads, the border being placed on the perimeter of the woven illuminating layer, the diffusing optical fibers extending beyond one edge of the woven illuminating layer, an end segment of the diffusing optical fibers being formed into a strand, the strand being attachable to a light source such that the light source is in optical communication with the strand. While binding threads 105 are defined as attaching the optical fibers 100 to the fabric layer 106, the optical fibers 100 may be attached to textile layer 106 by any other means known in the art.

Still further “lighted fabric”, in embodiments, may include within its meaning a configuration of optical fibers in which the diffusing optical fibers are parallel to one another, so that the woven illuminating layer is flat, or substantially flat. In an embodiment, the binding threads may comprise polyester. In an embodiment, the binding threads may be woven at a right angle (i.e. transverse to the longitudinal axis of the optical fibers) or other angle with respect to a longitudinal axis of the diffusing optical fibers, so as to form a warp-and-weft type weave. In an embodiment, the assembly seam may be welded, for example by cold welding. In an embodiment, the thickness of the border may be substantially 0.2 mm. In an embodiment, the width of the border may be substantially 20 mm. By virtue of these features, in an embodiment, the end of the diffusing optical fibers is not damaged during the production of the assembly seam. In an embodiment, the thickness of the textile layer may be substantially 0.8 mm. In an embodiment, the diameter of the optical fiber may be substantially 0.5 mm. This diameter is measured around the cladding. In an embodiment, the flexible coverage-providing article furthermore comprises a sleeve, the strand being assembled in the sleeve at the end of the strand, the sleeve being able to receive the light flux, i.e. light energy, generated in the optical output on the end of the diffusing optical fibers. In an embodiment, the sleeve may be of cylindrical, or substantially cylindrical, shape. In an embodiment, the sleeve may comprise aluminum. In one embodiment, the covering textile layer may be coated on one face so as to be water resistant, the woven illuminating layer being sewn to the other face. In an embodiment, the coating may comprise a water-resistant resin. In one embodiment, the coating may have antifungal properties. In an embodiment, the textile layer may comprise fibers made of acrylic. In an embodiment, the covering textile layer may be 100% composed of acrylic, its weave being of canvas type, the covering textile layer weighing 320 g/m·sup·2. The warp threads may have a strength at break of 140 decanewtons (daN), a tear strength of 3 to 3.3 daN, and for example of 3.3 daN, and an elongation at break of 30% to 34%, and for example of 30%. The weft threads may have a strength at break of 90 to 130 daN, for example of 130 daN, a tear strength of 2.5 daN and an elongation at break of 15% to 30%, and for example of 15%. The water resistance measured by the Schmerber test may be 400 to 1000 mm, and for example 1000 mm. The air permeability may be in a range of 2.5 l/m·sup·2/s to 31.62 l/m·sup·2/s, and for example 2.5 l/m·sup·2/s. The numerical values described above may vary by +/−10%. For example, such a covering textile layer is sold by the group DICKSON-GLEN RAVEN, under the trade name SUNBRELLA Plus. In an embodiment, the covering textile layer may be opaque. In an embodiment, the textile layer may comprise UV-resistant textile threads. In an embodiment, the binding threads are furthermore UV-resistant. In an embodiment, a film may be adhesively bonded or welded to the woven Illuminating layer on the side opposite to the covering textile layer. In an embodiment, the covering textile layer is a first covering textile layer, the flexible coverage-providing article furthermore comprising a second covering textile layer placed thereabove. In an embodiment, the first and second covering textile layers are sewn to each other on their borders, so that the assembly formed by the two covering textile layers is flat. In an embodiment, the first textile layer has an aperture of same size as the woven illuminating layer and the edges of this aperture are sewn with the borders of the woven illuminating layer to the first textile layer. In an embodiment, the second textile layer is water resistant. By virtue of these features, the water resistance of the flexible coverage-providing article is improved. In an embodiment, the flexible coverage-providing article furthermore comprises a canvas segment sewn to the covering textile layer around the end of the diffusing optical fibers formed into a strand, in order that the strand be placed between the canvas segment and the covering textile layer.

As used herein, “resin” means any resin including but not limited to any two part epoxy resin, whether it comprises a urethane component, or not. I.e., “resin” includes within its meaning co-cure resins and all other resins.

As used herein, “co-cure resin” includes within its meaning resins comprising co-cured urethane and vinyl ester, epoxy, or unsaturated polyester components. The urethane component is from 10 to 50 wt. %, and the urethane and vinyl ester, epoxy, or unsaturated polyester reactants are combined under conditions effective to cure both components in the same cure cycle. “Co-cured” means that the reactions involved in producing a urethane polymer (i.e., reaction of a polyisocyanate or NCO-terminated prepolymer with polyols and hydroxy or amine-functional extenders) take place essentially concurrently with reactions involved in converting vinyl ester, epoxy, or unsaturated polyester reactants to cured products. Unsaturated polyester and vinyl ester resins generally react with styrene and free-radical initiators to produce a cured thermoset polyester or vinyl ester. Epoxy resins generally react with “hardeners” or curing agents to produce a cured epoxy component. The co-cured product comprising the urethane and polyester, epoxy, or vinyl ester components is distinguishable from an interpenetrating network (IPN) because there can be some reactions involving chains of each network.

Further, “co-cured resin” includes within its meaning resins for which the reactions involved in producing a urethane polymer (i.e., reaction of a polyisocyanate or NCO-terminated prepolymer with polyols and hydroxy or amine-functional extenders) take place essentially concurrently with reactions involved in converting vinyl ester, epoxy, or unsaturated polyester reactants to cured products. Unsaturated polyester and vinyl ester resins generally react with styrene and free-radical initiators to produce a cured thermoset polyester or vinyl ester. Epoxy resins generally react with “hardeners” or curing agents to produce a cured epoxy component. Co-cured resin comprising the urethane and polyester, epoxy, or vinyl ester components is distinguishable from an interpenetrating network (IPN) because there can be some reactions involving chains of each network. The urethane component is generated from any desired combination of urethane reactants, including polyisocyanates, isocyanate-terminated prepolymers, polyols, and chain extenders, all of which are well known and commercially available. The polyisocyanate can be aromatic or aliphatic. Aromatic polyisocyanates include, e.g., toluene diisocyanates (TDI), 4,4′-diphenylmethane diisocyanates (MDI), or polymeric diisocyanates (PMDI), or the like. Aliphatic polyisocyanates include, e.g., hexamethylene diisocyanate (HDI), hydrogenated MDI, cyclohexane diisocyanate (CHDI), isophorone diisocyanate (IPDI), trimethyl or tetramethylhexamethylene diisocyanate (TMXDI), or the like. Isocyanate-terminated prepolymers are made with any of the above polyisocyanates and a polyol; many prepolymers are commercially available. Suitable polyols have molecular weights from 500 to 10,000 and functionalities from 2 to 6. Typically, these are hydroxyl or amine-terminated polyether or polyester polyols, most commonly a polyether or polyester diol or triol. The polyol can have higher functionalities, as in alkoxylated sucrose polyols or the like. Suitable chain extenders are usually low-molecular-weight diols or diamines such as ethylene glycol, diethylene glycol, 1,4-butanediol, 1,6-hexanediol, ethylene diamine, 4,4′-methylene-bis(2-chloroaniline) (“MOCA”), and the like. The urethane system can be a one- or two-component system. It can be a pure urethane system (i.e., hydroxyl-terminated reactants only), a polyurea (amine-terminated polyols and/or amine extenders), or a combination or mixture of these. For more information about reactants and processes used to make urethane polymers, see W. F. Gum, W. Riese, and H. Ulrich, Reaction Polymers: Polyurethanes, Epoxies, Unsaturated Polyesters, Phenolics, Special Polymers, and Additives; Chemistry, Technology, Applications, Markets, Hanser Publishers, NY (1992), especially pp. 50-124. Co-cured resins may be fully formulated using fully formulated polyurethane and/or polyurea products. Numerous examples below, for instance, utilize Selby™ N300 CR (product of BASF), a two-component polyurethane based on an aliphatic polyisocyanate and designed for use as a floor coating or its combination with EnviroLastic® resin (product of Sherwin-Williams) or Line-X® resin (Line-X, Inc.), polyureas commonly used to coat truck bed liners. Of course, the skilled person has discretion to customize or formulate the urethane and or urea from the usual building blocks or to simply use commercially available products. The urethane component is from 10 to 50 wt. %, preferably from 10 to 25 wt. %, based on the amount of gel coat. Suitable unsaturated polyester resins are well known. They are generally polymers of intermediate molecular weight made by condensing glycols, maleic anhydride, and dicarboxylic acids (or their anhydrides) to give a resin having a targeted acid number. Typical glycols include ethylene glycol, propylene glycol, diethylene glycol, dipropylene glycol, alkoxylated bisphenol A, cyclohexane dimethanol, neopentyl glycol, and the like. The dicarboxylic acid or anhydride can be aromatic, aliphatic, or a mixture of these. Typical examples include phthalic anhydride, isophthalic acid, terephthalic acid, adipic acid, succinic acid, tetrabromophthalic anhydride, tetrahydrophthalic anhydride, maleic acid, fumaric acid, and the like. Maleic anhydride is used to provide a crosslinkable carbon-carbon double bond capable of reacting with the ethylenic monomer in the presence of the free-radical initiator. Suitable ethylenic monomers include, for example styrene, alpha-methylstyrene, divinylbenzene, methyl methacrylate, butyl acrylate, vinyl toluene, and the like, or their mixtures. Styrene is preferred. Preferred unsaturated polyester resins for use in gel coats are based on isophthalic acid, particularly resins formulated from maleic anhydride, isophthalic acid, and neopentyl glycol. The unsaturated polyester resin can be formulated from the starting materials described above or it can be obtained commercially. Suppliers of suitable unsaturated polyester resins include, for example, CCP Polymers, Interplastic Corporation, Reichhold, Ashland, and others.

Still further, “co-cured resin” includes within its meaning all descriptions of co-cured material compositions, and all processes for producing co-cured resins, set forth in the '468 patent, the '791 Patent, the '100 patent, and the '322 application. “Co-cure resin” may be characterizes as having a percentage urethane component, by weight, to achieve a desired durability, hardness, and flexibility. For example, a “30% co-cure resin” comprises 30% urethane components by weight.

As used herein, “light source” and “source of light energy” includes within their meanings any source of light energy including, for example and not by way of limitation, electrically powered light sources such as light emitting diodes (LEDs), lasers, laser diodes, incandescent lights, halogen lights, and all types of electrically powered light sources as are known in the art, chemical light sources, ambient light that is reflected or refracted, or both, possibly, but not necessarily, by one or more lenses, and all other known sources of light, such that light is coupled into the optical fibers of the invention causing light energy to propagate along the length of the optical fiber. Light sources may produce varying colors of light, and may also produce light that varies in color over time. “Light source” may also refer to one, or a plurality, of individual lighting elements such as LEDs, lasers, laser diodes, incandescent lights, halogen lights, and all types of electrically powered light sources as are known in the art, chemical light sources, ambient (i.e. natural, or environmental) light that is reflected or refracted, or both, possibly, but not necessarily, by one or more lenses, and all other known sources of light, such that light is coupled into the optical fibers of the invention causing light energy to propagate along the length of the optical fibers. In an embodiment, the light source may comprise a lens able to focus the light emitted in by the LED onto the end of the diffusing optical fibers. The light source may be in electrical communication with a source of electric power such as electrical alternating current house power, batteries, photovoltaic cells or other known sources of electric power that is able to power the light source such that it produces light energy.

As used herein, “tacky” includes within its meaning a resin that has been intentionally cured so as to produce unreacted sites allowing bonding or adhering to another structure, for instance a layer of a laminated structure, or a resin used to create a layer of a laminated structure.

As used herein, “composite structure” and “composite materials” include within their meanings any structure compromised of two or more materials. As an example, and not by way of limitation, any structure comprised of fibers, strands, fabrics or particles of any type embedded in a matrix material, such as, for example, a resin material, is a composite structure comprising composite materials. For example, fiber reinforced polymer (FRP), or fiberglass, structures are a type of composite structure. As another non-limiting example, laminated structures that comprises two or more layers bonded together are composite structures. Some examples of laminated composites include bimetals, clad metals, laminated glass, plastic-based laminates, and fibrous composite laminates. Further, a hybrid class of composites, called laminated fiber-reinforced composites, is a further example of a composite structure involving both fibrous composites and lamination techniques. In laminated composite structures, a fiber direction of each layer of fiber-reinforced composites may be oriented in a direction different from the direction of other layers in order to achieve strength and stiffness in different directions.

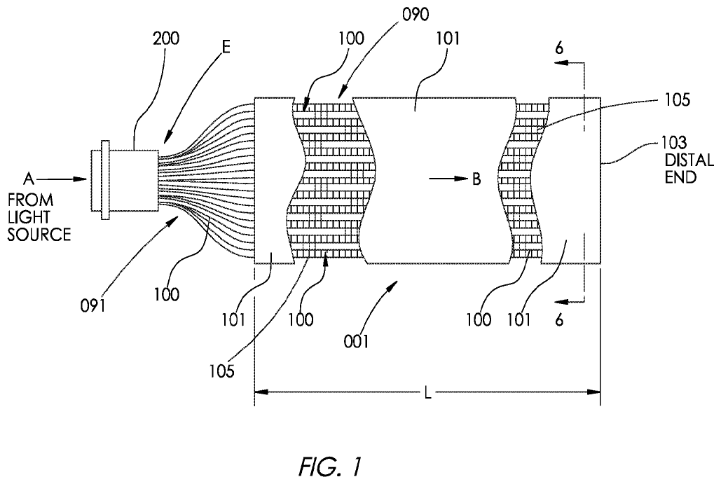

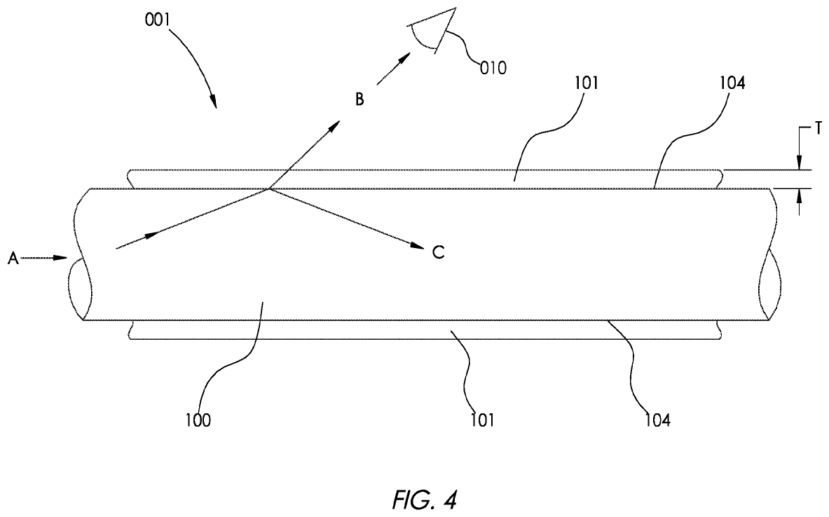

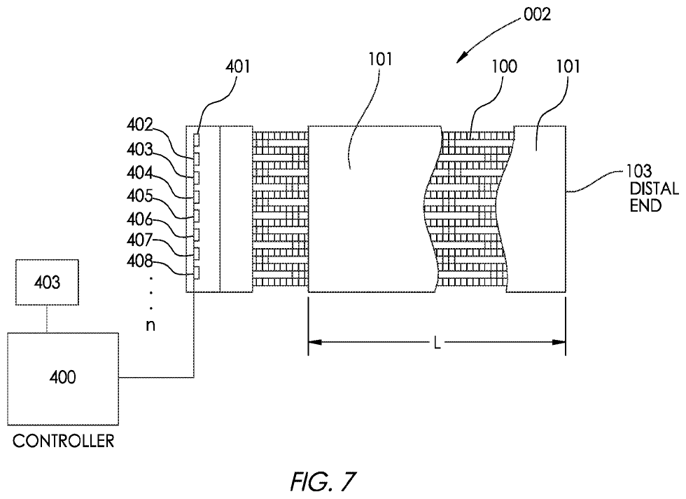

Referring now to FIG. 1, a lighting apparatus 001 of the invention is depicted. The lighting apparatus 001 may comprise a woven illuminating fabric 090 comprising at least optical fiber attached to a fabric, such as described in the '119 patent, in which the optical fiber strands 091 may be captured, or terminated, in optical connector 200 for connecting optical fiber strands 091 to a light source 201 (see FIG. 3) such that light source 201 is in optical communication with the optical fiber strands 091 for communicating optical energy A from light source 201, through optical fiber strands 091, into optical fibers 100 that comprise woven illuminating fabric 090. Woven illuminating fabric 090 may be comprised of one or more optical fibers 100 running in a lengthwise direction, i.e. in the direction of arrow B, attached, in embodiments, to a textile layer 106 (see FIG. 6), for example by interwoven binding threads 105 as is further depicted in FIG. 6. In an embodiment, the lighting apparatus 001 may comprise a plurality of optical fibers 100 running lengthwise in the direction of arrow B, held together by binding threads 105, forming a woven illuminating fabric 090, which is a woven fabric like structure able to be saturated with a resin 101 such as, but not limited to, a co-cure resin. The fabric like structure is then saturated with a resin, which may be a co-cure resin, for example a 30% co-cure resin, forming a structure comprising optical fibers 100 in contact with the cured co-cure resin 101. The use of resin 101 to saturate the fabric like structure results in a lighting apparatus 001 that is able to be lighted by the use of light source 201 as described herein. In the case in which resin 101 is a co-cure resin, the resin-encapsulated woven illuminating fabric 090 running for a length L is also flexible in any direction, tough and durable. The resin, which may be a co-cure resin, may be formulated and intentionally cured so as to remain tacky after curing, simplifying assembly of a composite structure comprising a lighting apparatus of the invention. The surface of the textile to which the optical fibers are attached forms a light-emitting surface of the woven illuminating fabric 090. Light emitted by the lighting apparatus is emitted from this light-emitting surface of the woven illuminating fabric 090, forming a light emitting surface of the lighting apparatus and system of the invention 001. In embodiments, it is not necessary that optical fibers 100 run in the direction B. Optical fibers 100 may run in any direction or combination of directions. Lighting apparatus distal end 103 is called out for reference.

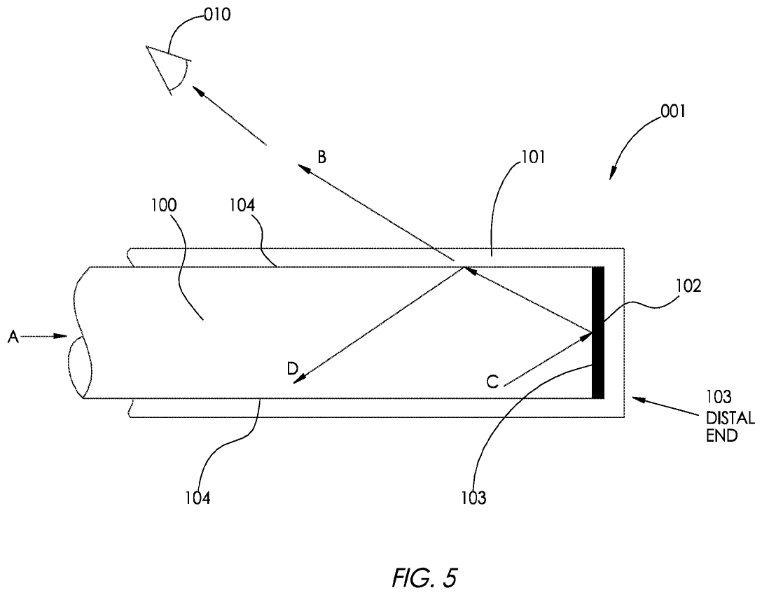

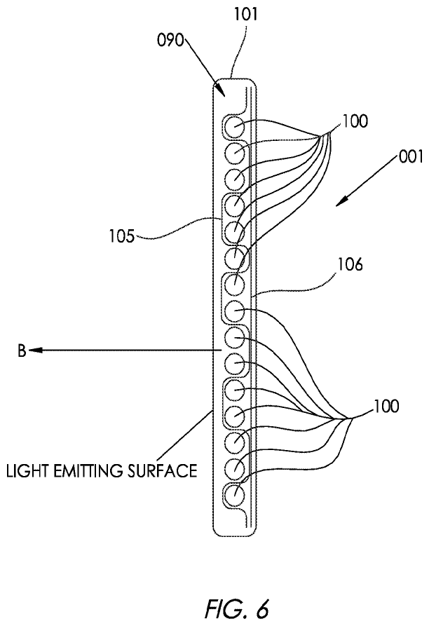

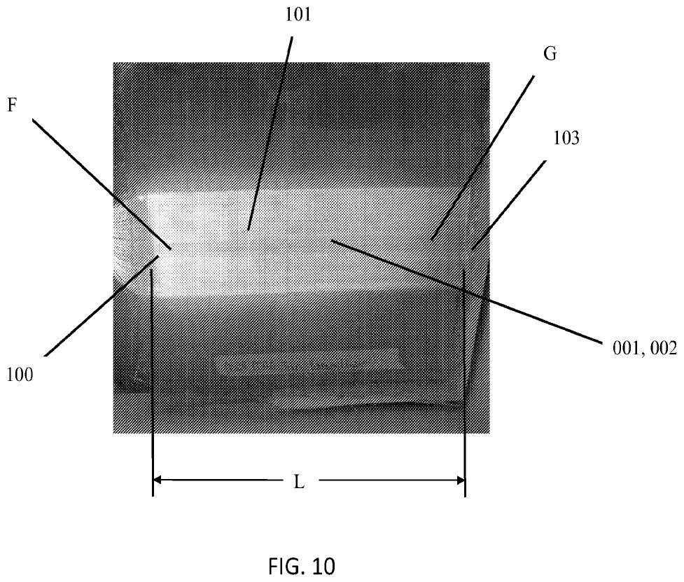

It was discovered unexpectedly that the use of co-cure resin provides vastly superior optical qualities of the lighting apparatus 001 over such qualities as produced when other resins, such as polyester resins and epoxy resins, are utilized as resin 101, as follows. During experimentation it was discovered that the use of non-co-cure resins allow a significant amount of light to escape optical fibers 100 such that very little, if any at all, light energy propagates to the end of the optical fibers 100 that comprise lighting apparatus 001. This undesired effect means that there is a degradation in light output along length L such that a significant amount of light exits lighting apparatus 001 near the connector rise and of the lighting apparatus, but the light emitted from the lighting apparatus 001 diminishes along length L such that the lighting apparatus 001 exhibits a nonlinear light output along length L. However, when resin 101 is a co-cure resin, sufficient light is reflected back into optical fibers 100 from the fiber-resin boundary so as to enable a greater amount of light to propagate along optical fibers 100 along length L such that uniform lighting is achieved along length L. This was an unexpected result and may be due, at least in part, to differences in the optical index of refraction between co-cure resins and non-co-cure resins. Therefore, it is a preferred, and superior, embodiment of the invention that resin 101 comprise a co-cure resin so as to achieve uniform lighting along length L, as is further depicted in FIGS. 10-13. The propagation of light along optical fibers 100, and the exiting of light from the optical fibers 100 in a direction transverse to the longitudinal axis of the optical fibers 100, are depicted further in FIGS. 4 and 5. Preferably, the ratio of urethane component of the co-cure resin is in a range of 25%-35%. Thus, while the scope of the invention includes the use of any resin such as epoxy resins without any urethane component, it is a preferred embodiment to utilize co-cure resins, and, in embodiments, co-sure resins having a urethane component in the range of 25%-35%.

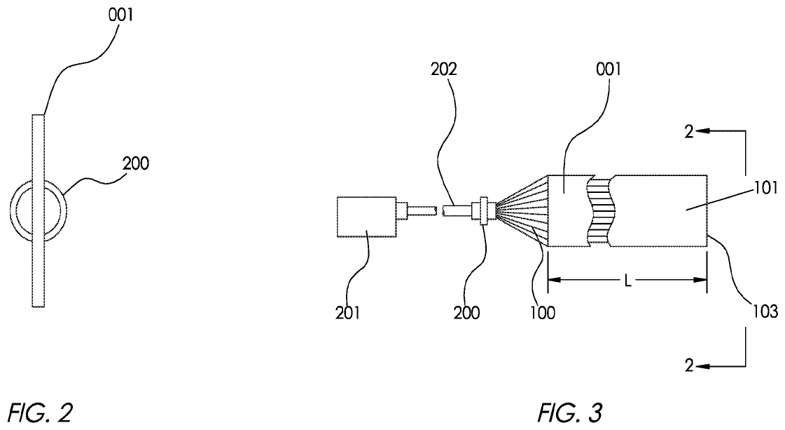

Referring now to FIG. 2, an end view of the lighting apparatus of the invention 001 is provided. Connector 200 is shown for reference.

Referring now to FIG. 3, an optical lighting system of the invention is depicted. Light source 201 may be in optical communication with the optical fibers 100 of the invention via optical cable 202 via connectors 200, which may be a mating pair of optical connectors. The lighting apparatus of the invention 001 may comprise optical fibers 100 running lengthwise along length L to a distal end of the lighting apparatus 103. Length L may be any length as desired by a user for a particular application of the lighting apparatus 001. In embodiments, optical fibers 100 may be at least partially encapsulated by resin 101 without the presence of any fabric.

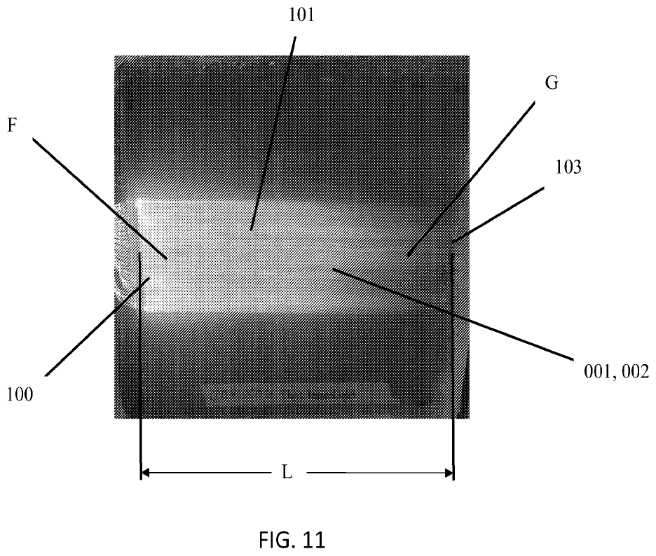

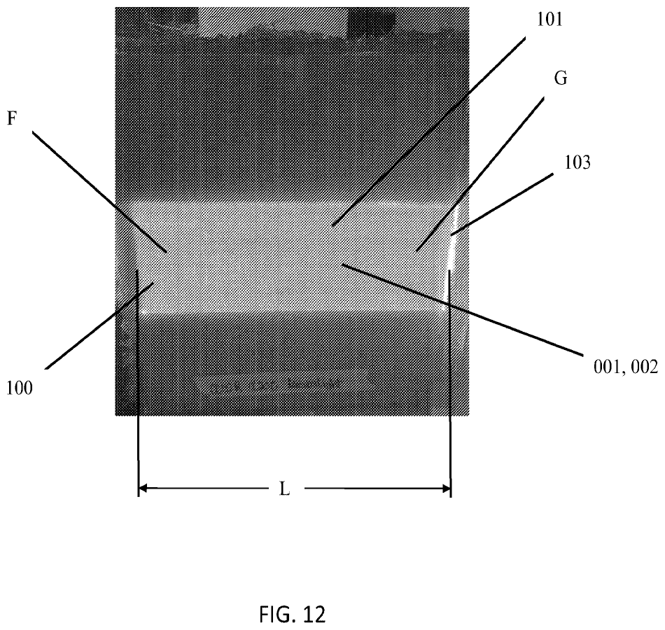

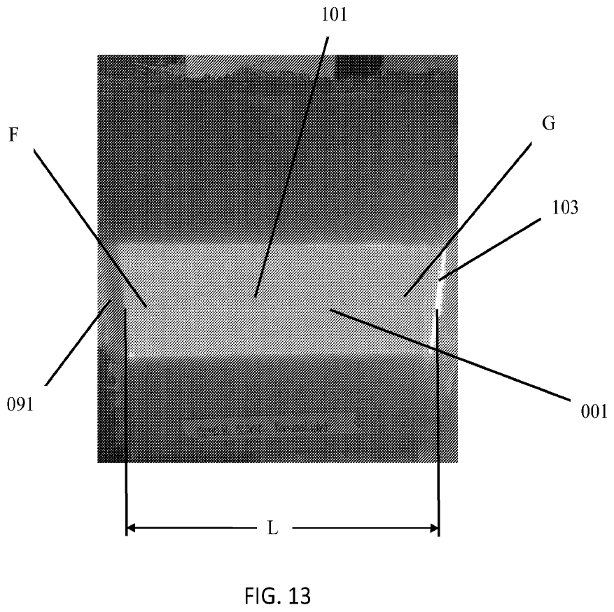

Referring now to FIG. 4, propagation of light energy A along optical fiber 100 is depicted. Once woven illuminating layer 090 is saturated with resin, which may be a co-cure resin 101, light energy A that is injected into fibers 100 from light source 201 propagates along the length L of optical fibers 100. Some of the light energy propagating along optical fibers 100 will be directionally oriented such that it encounters the boundary between an outer surface 104 of optical fiber 100 and resin 101, which may be but is not necessarily a co-cure resin. A difference in the index of refraction of the material comprising optical fiber 100 and resin 101 will cause a portion C of the light energy A to be reflected back into optical fiber 100 at boundary 104 as depicted in FIG. 4, and will also allow a portion of light energy B to exit optical fiber 100 so that it may be observed by an observer 010. This exiting light energy B causes the lighting apparatus 001 to provide a desired lighting effect in the area or volume adjacent to lighting apparatus 001, which is an object of the invention. In embodiments, it is generally desired that the lighting affect produced by light energy be exiting optical fibers 100 be uniform along length L of the lighting apparatus 001. The difference in the index of refraction of the materials comprising optical fiber 100 and resin 101 may be varied to achieve a desired amount of light energy reflection C and light energy exit B such that a desired amount of exit light energy B is achieved, allowing uniform, or substantially uniform, light energy output of the lighting apparatus of the invention 001 along length L as depicted in FIGS. 12 and 13. It was discovered experimentally that the use of co-cure resins cause a higher degree of reflection at the fiber-resin boundary than non-co-cure resins, enabling lighting apparatuses 001 of greater length L having uniform, or substantially uniform, lighting along the entirety of their length L when co-cure resins are used, while the use of non-co-cure polyester resins produced an undesirably high level of light to exit optical fiber 100 is depicted by arrow B, resulting in non-uniform light energy output B along length L of lighting apparatuses 001 as depicted in FIGS. 10 and 11. This result was not expected, and was discovered by accident when experimenting with saturating a woven illuminating layer with different types of resins, and with co-cure resins of varying urethane percentage by weight, to determine if it would be possible to create a lighting apparatus such as lighting apparatus 001. It was discovered that the use of co-cure resin provides the distinct advantages over the use of non-co-cure resins described herein, resulting in the desired uniform lining along the length L of lighting apparatus 001. In any embodiment, the resin layer 101 may be characterized as having a thickness T.

Referring now to FIG. 5, a cross-section view of an embodiment of a distal end 103 of optical fiber 100 is depicted. Resin 101, which may be a co-cure resin, is in contact with an outer surface 104 of optical fiber 100, causing the internal reflection and propagation of light energy along optical fiber 100 as described elsewhere herein. When the light propagates along length L (see FIG. 1) of optical fiber 100 and reaches distal end 103, it may be reflected back along the length L of optical fiber 100 as depicted by light energy D. Light energy D may impact the boundary between optical fiber 100 and resin 101 at the outer surface 104 of optical fiber 100, causing some light energy to be reflected back into the optical fiber 100, depicted as arrow B, and allowing a portion of light energy to escape optical fiber 100 as depicted by arrow D. This light energy B appears to a user as light energy that is exiting the lighting apparatus, and therefore providing the desired lighting effect as observed by a user 010. In embodiments, a reflective material 102 may be applied to optical fiber distal end 103 to increase the amount of light be reflected back into optical fiber 100. Reflective material 102 may be a reflective sheet material or other material that is adhered to optical fiber distal end 103, or it may be an applied coating that is applied to optical fiber distal end 103 that is cured to form a reflective surface at the distal end 103 of optical fiber 100. The use of a reflective material 102 enables reflection of light energy D back into fiber 100, and may cause the lighting apparatus 001 to appear brighter, enabling greater light output, or, alternatively, allowing the use of lower output power light sources 201 to achieve the same lighting effect as it no reflective material 102 were used.

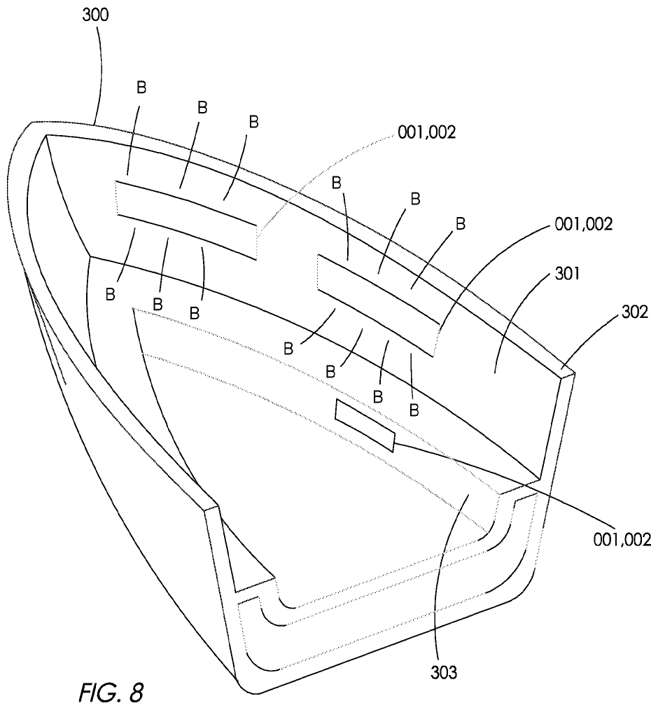

Referring now to FIG. 6, a cross section of a non-limiting, exemplary, embodiment of the invention comprising a lighted fabric such as woven illuminating layer 090, which may be the woven illuminating layer as described in the '611 patent, that has been saturated by a resin 101 which has been cured or substantially cured, which may be tacky, and which may be a co-cure resin, is depicted. In embodiments, a lighted fabric such as, for example, woven illuminating layer 090, may have a textile layer 106, one or more (preferably, a plurality of) optical fibers 100 which may, but do not necessarily run in a direction along the length of textile layer 106, and binding threads 105, or some other attachment means for attaching optical fibers 100 to textile layer 106. running in a direction having a component that is transverse to the direction of run of the optical fibers 100, the binding threads 105 weaving the optical fibers 100 with the textile layer 106 and thus holding the optical fibers 100 in place with the textile layer 106. Textile layer 106 may be any fabric or woven fabric layer. In embodiments, textile layer 106 may comprise polyester fibers. In embodiments, textile layer 106 may comprise fibers made of acrylic. In embodiments, the textile layer 106 may be 100% composed of acrylic, its weave being of canvas type, the covering textile layer weighing 320 g/m·sup·2. The warp threads may have a strength at break of 140 decanewtons (daN), a tear strength of 3 to 3.3 daN, and for example of 3.3 daN, and an elongation at break of 30% to 34%, and for example of 30%. The weft threads may have a strength at break of 90 to 130 daN, for example of 130 daN, a tear strength of 2.5 daN and an elongation at break of 15% to 30%, and for example of 15%. Woven illuminating layer 090, including textile layer 106 and optical fibers 100, may be saturated with a resin 101 which may be, but is not limited to, a co-cure resin, that is subsequently cured, forming lighting apparatus 001 or 002 (see FIG. 7), or any equivalent embodiment thereof. It is to be understood that the embodiment of the woven illuminating layer 090 depicted in FIG. 6 is merely exemplary, and that, generally, woven illuminating layer 090 may be any structure comprising optical fibers attached to a textile layer, whether or not attached by binding threads or some other structure or process, forming an optical fiber-textile layer combination, wherein the optical fiber-textile layer combination is saturated with a resin that is subsequently cured. In embodiments the resin 101 may be, but is not necessarily, a co-cure resin, and, as taught elsewhere herein, experiments to date show that use of co-cure resin leads to unexpected results and may be a best mode for making the invention. In embodiments, the co-cure resin may comprise a urethane component in any ratio, but experimental results show that urethane component in a range of 25%-35% by weight may be optimal for light transmissivity, and flexibility and toughness of the resulting lighting element. The lighted fabric may have light emitting surface opposite the side of optical fibers 100 from textile layer 106, with light energy emitting from the optical fibers as depicted by arrow B.

Referring now to FIG. 7, an embodiment of the lighting apparatus of the invention 002 as depicted in which a plurality of light sources, or active lighting elements, 401 through n, is depicted by using a plurality of discrete lighting elements 401 up to n; and, by connecting the lighting elements to controller 400, the light output and color of each light element may be individually controlled to produce any desired pattern of alternating colors to achieve any desired visual effects such as solid colors, strips of color, varying light intensity and other desired effects along length L, such as changing colors or rotating colors, or any other combination of visual effects. In embodiments, a sensor 403 may be in communication controller 400 such that the visual effects may change in time to a signal produced by sensor 403. For example, sensor 403 may be a microphone producing an audio signal that is processed by controller 400 such that lighting elements 401 up to n, may change color or intensity in time with music or other external audio sources. Co-cure resin 101, optical fibers 100 and optical fiber distal end 103 are depicted for reference.

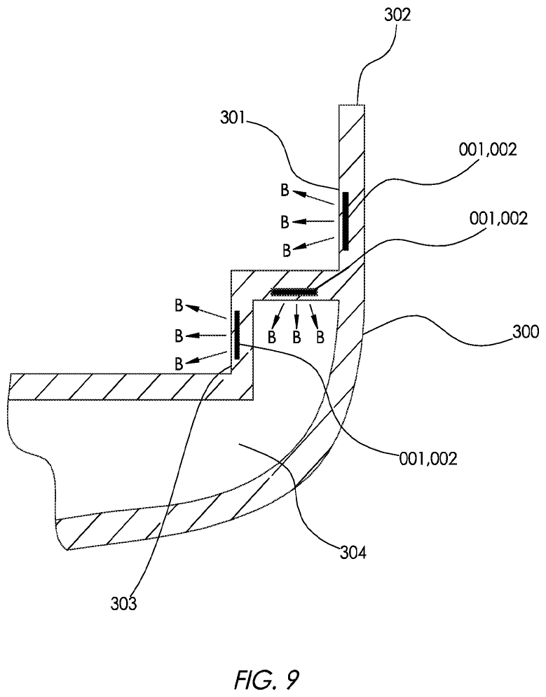

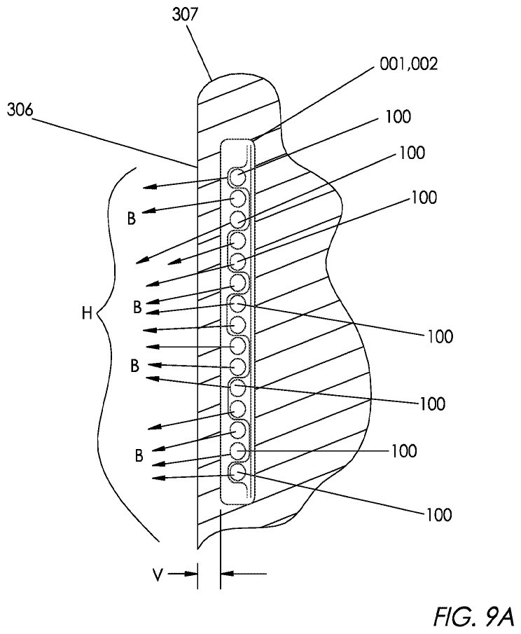

Referring now to FIGS. 8 and 9, an exemplary use case of the lighting apparatus of the invention 001 or 002 used in one embodiment of an object body structure is depicted. Referring to FIGS. 8 and 9, the object body structure (in this exemplary use case) is a portion of a bow 300 of a boat, in which a plurality of lighting apparatuses 001 or 002 have been embedded just underneath the gelcoat of the structural composite layers forming the boat hull. Boat surfaces 301 and 303 may comprise one or more lighting apparatuses 001 that may be independently controlled such that a desired amount of light energy B is applied to an adjacent floor area, bench area, or any other area of the boat. Lighting apparatuses 001 may be fabricated into a boat hull, or any other surface of a boat, at the time of boat manufacture, when the structural composites forming the boat hull are formed in molds (or by any other structural composite manufacturing process). The boat application depicted in FIGS. 8 and 9 are exemplary in nature and are intended to depict, in non-limiting fashion, just one of many uses of the lighting apparatus 001 of the invention. The scope of the invention includes any boat or other structures comprising structural composites, including but not limited to structures that are fabricated in molds, in which lighting apparatuses 001 of the invention are embedded. Further to the use case in which the object body structure is a boat as depicted in FIGS. 8 and 9, lighting apparatus' of the invention 001 and/or 002 could be present in the gunwale portion of the boat 302, or in internal hull spaces 304. There are no limits to the type of object body structures in which the lighting apparatus of the invention may be utilized.

Referring now to FIG. 9A, a view of a generalized embodiment of a use case of the invention is depicted. Any object body structure 307 (which, may be, for example, the bow portion of a boat 300 as depicted in FIGS. 8 and 9), may comprise a lighting apparatus 001 or 002 of the invention, embedded a distance V beneath a surface 306 of the object body structure 307. Dimension V may be selected based on a desired light output intensity H in the area or volume adjacent to surface 306. Light output intensity H is the summation of emitted light energy B from each of the optical fibers 100. Thus light output intensity H is a function of the following: the amount of light energy propagating through each optical fiber 100, the relationship between the refractive index of the optical fiber and the material comprising the object body structure 307 (shown in cross hatching in FIG. 9A), the optical transmissivity of the material comprising the object body structure 307, and the distance V. All, or any portion of, these factors, in any combination, may be selected and/or adjusted to achieve a desired light output intensity H in the area or volume adjacent to surface 306. The material comprising the object body structure 307 may be any material or any combination of materials. In exemplary embodiments, and not by way of limitation, object body structure 307 may comprise any plastic, composite material, glass or any combination of these materials. These are just a few examples of many materials that may comprise object body structure 307. Further examples include object body structures forming architectural features such as arches, panels, wall or ceiling portions, or other features of buildings, interior and/or exterior.

Still referring to FIG. 9A, an embodiment of the invention may form a lighted object body structure 307, comprising: an object body structure 307 having an outer surface 306, at least one optical fiber 100 having a length and a longitudinal axis, and an outer surface, wherein the at least one optical fiber 100 is attached to a textile layer 106 (see FIG. 6), wherein textile layer 106 and the at least one optical fiber 100 are covered by a resin 101 (see FIGS. 5 and 6) that has been cured, forming a lighting apparatus 001 or 002 wherein the cured resin 101 is in contact with at least a portion of the outer surface of the at least one optical fiber 100, forming a fiber-resin boundary 104 (see FIG. 5), for at least a portion of the length of the optical fiber; wherein the at least one optical fiber 100 is attachable to a source of light energy 201 (see FIG. 3) so as to be in optical communication with the source of light energy 201, such that light energy from the source of light energy 201 is communicated to and received by the at least one optical fiber 100 and propagates along the at least one optical fiber 100 when the source of light energy 201 is activated; wherein an index of refraction of the cured resin 101 is related to an index of refraction of the at least one optical fiber 100 such that a desired portion of the light energy propagating along the at least one optical fiber 100 escapes the at least one optical fiber B (see FIGS. 4 and 5) when it encounters the fiber-resin boundary 104 and is observable from outside the object body structure; while a remainder of the light energy C propagating along the at least one optical fiber 100 is reflected back into the optical fiber 100 and continues to propagate along the fiber until it again encounters the fiber-resin boundary 104; and wherein the lighting apparatus 001 or 002 is disposed in the object body structure 307 in proximity to an outer surface of the object body structure 307 by a distance V such that the light energy escaping the fiber-resin boundary 104 is observable from outside the object body structure outer surface, in a desired light output intensity H. Light output intensity H may be adjusted by selecting values for any one of, or any combination of: the amount of light energy propagating through each optical fiber 100, the relationship between the refractive index of the optical fiber 100 and the material comprising the object body structure 307 (shown in cross hatching in FIG. 9A), the optical transmissivity of the material comprising the object body structure 307, and the distance V.

Referring now to FIGS. 10 and 11, light output along two test samples of exemplary embodiment of lighting apparatus 001 comprising non-co-cure resin used for resin 101 is shown photographically. It can readily be seen from the photographs in FIGS. 10 and 11 that there is a significant degradation, i.e. reduction or non-uniformity of light energy output B, B along length L of lighting apparatus 001, the light output being greater at area F at the input end of optical fibers 100, and diminished at area G near the distal end 103, when non-co-cure resin (i.e. resin that has no urethane component) is used for resin 101.

Referring now to FIGS. 12 and 13, light output along two test samples of exemplary embodiment of lighting apparatus 001 comprising co-cure resin for resin 101 is shown photographically. It can readily be seen from the photographs in FIGS. 12 and 13 that there is desired uniformity in light output along length L of lighting apparatus 001 or 002 using non-co-cure resin for resin 101. The light output at the input end of the lighting apparatus at area G, near the input of light energy into optical fibers 100, is the same, or substantially the same, as the light output intensity at the distal end 103 at area G. The superior performance of the use of co-cure resins (i.e., resins that have a urethane component) to saturate woven illuminating fabric 090 is readily seen by comparing FIGS. 10 and 11 to FIGS. 12 and 13. Using the co-cure resin, a uniform, or substantially uniform, light output intensity along length L is achieved. This, generally, is a desired result of the invention, although, in embodiments, a reduction of light energy output along length L of optical fibers 100 may be desired. In such cases and embodiments, a non-co-cure resin may be used as resin 101.

The invention also comprises a method for producing a lighting apparatus, comprising the steps of: providing a smooth molding surface, such as a mold; applying a layer of clear (or other) gel coat to the smooth molding surface; applying a first layer of resin 101 to the clear gel coat; applying a lighted fabric comprising a woven illuminating layer 090 to the first layer of resin, the lighted fabric having a light emitting side, the light emitting side oriented against the first layer of resin; applying a second layer of resin to the non-light emitting side of the lighted fabric; applying a layer of white gel coat to the second layer of resin to form a background layer; and curing the layers of resin; wherein the lighted fabric comprises: at least one optical fiber 100 having a length L and a longitudinal axis, and an outer surface; wherein the at least one optical fiber 100 is attached to a textile layer 106; wherein the textile layer 106 and the at least one optical fiber 100 are saturated and covered by the first and second layers of resin prior to curing, and wherein the first and second cured resin layers are in contact with at least a portion of the outer surface 104 of the at least one optical fiber 100, forming a fiber-resin boundary, for at least a portion of the length of the optical fiber 100; wherein the at least one optical fiber 100 is attachable to a source of light energy so as to be in optical communication with the source of light energy 201, such that light energy from the source of light energy 201 is communicated to and received by the at least one optical fiber 100 and propagates along the at least one optical fiber 100 when the source of light energy 201 is activated; and wherein an index of refraction of the cured first and second layers of resin 101 is related to an index of refraction of the at least one optical fiber 100 such that a desired portion of the light energy propagating along the at least one optical fiber 100 escapes the at least one optical fiber 100 when it encounters the fiber-resin boundary 104 and is observable from outside the composite structure; while the remainder of the energy propagating along the at least one optical fiber 100 is reflected back into the optical fiber 100 and continues to propagate along the optical fiber 100 until it again encounters the fiber-resin boundary. This method is just one of many exemplary methods of producing a lighting apparatus of the invention. In embodiments, the at least one optical fiber 100 is further defined as a plurality of optical fibers 100, each having an elongate shape having a longitudinal axis, each longitudinal axis of each of the optical fibers 100 running in the same direction. The optical fibers 100 of the plurality of optical fibers 100 may run in the same direction and may be arranged to form a linear array when viewed in a cross-section taken transverse to the longitudinal axis of the plurality of optical fibers 100 (see FIG. 6). In embodiments, the first and second resin layers may comprise a co-cure resin. In embodiments, the co-cure resin may comprise urethane in a range of 24%-35% by weight. The at least one optical fiber 100 may be attached to the textile layer 106 by weaving, using a binding thread, forming a woven illuminating layer. The intensity of the desired light energy escaping from the fiber-resin boundary is uniform, or substantially uniform, along the length of the optical fiber 100, especially when the first and second layers of resin are co-cure resin. In embodiments, the cured resin may be intentionally cured such that it remains tacky after curing, facilitating placement of the lighting apparatus 001 in the laminating layers of a composite structure, during the lay-up steps of a molding process. The lighting apparatus 001 produced by this method may be used in any number of use cases where lighting is desired; when connected to light source 201, the lighting apparatus 001 and light source 201, and any interconnecting optically transmissive fibers, form a lighting system that may be used in any number of use cases where lighting is desired.

The invention also comprises a method for producing a lighted composite structure, comprising: providing a smooth molding surface for molding a desired surface of a composite structure; applying a layer of clear gel coat to the smooth molding surface; applying a first layer of resin 101 to the clear gel coat; applying a lighted fabric to the layer of co-cure resin, the lighted fabric having a light emitting side, the light emitting side oriented against the first layer of resin; applying a second layer of resin 101 to the non-light emitting side of the lighted fabric; applying one or more alternating fabric-resin layers to achieve a desired structural composite structure; and curing the layers of resin; wherein the lighted fabric comprises: at least one optical fiber 100 having a length and a longitudinal axis, and an outer surface; wherein the at least one optical fiber 100 is attached to a textile layer 106; wherein the textile layer 106 and the at least one optical fiber 100 are saturated by the first and second layer of resin 101 prior to curing, and wherein the first and second layer cured resin 101 is in contact with at least a portion of the outer surface of the at least one optical fiber 100, forming a fiber-resin boundary, for at least a portion of the length of the optical fiber 100; wherein the at least one optical fiber 100 is attachable to a source of light energy 201 so as to be in optical communication with the source of light energy 201, such that light energy from the source of light energy 201 is communicated to and received by the at least one optical fiber 100 and propagates along the at least one optical fiber 100 when the source of light energy 201 is activated; and wherein an index of refraction of the first and second layer cured resin 101 is related to an index of refraction of the at least one optical fiber 100 such that a desired portion of the light energy propagating along the at least one optical fiber 100 such that a desired amount of light energy escapes the at least one optical fiber 100 when it encounters the fiber-resin boundary and is observable from outside the composite structure; while the remainder of the energy propagating along the at least one optical fiber 100 is reflected back into the optical fiber 100 and continues to propagate along optical fiber 100 until it again encounters the fiber-resin boundary. The at least one optical fiber 100 may be further defined as a plurality of optical fibers 100, each having an elongate shape having a longitudinal axis, each longitudinal axis of each of the optical fibers running in the same direction. The optical fibers 100 of the plurality of optical fibers 100 run in the same direction and are arranged to form a linear array when viewed in a cross-section taken transverse to the longitudinal axis of the plurality of optical fibers 100. In embodiments, the resin may be a co-cure resin. The co-cure resin may comprise a urethane component in a range of 25%-35% by weight. The at least one optical fiber may be attached to the textile layer by weaving, using a binding thread, forming a woven illuminating layer. The intensity of the desired light energy escaping from the fiber-resin boundary is uniform, or substantially uniform, along the length of the optical fiber(s) 100.

Although a detailed description as provided in this application contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

The method steps of the invention may be carried out in any order, and, in embodiments, the method of the invention may not necessarily comprise every step described herein. It is to be understood that the embodiments of the system and method of the invention described herein are exemplary only and that the scope of the intended invention as set forth in the written description, drawings and claims includes all alternate embodiments and legal equivalents thereof.

What is claimed is:

1. A lighting apparatus, comprising:
at least one optical fiber having a length and a longitudinal axis, and an outer surface;
wherein the at least one optical fiber is attached to a textile layer;
wherein the textile layer and the at least one optical fiber are covered and saturated by a resin that has been cured, wherein the cured resin is in contact with at least a portion of the outer surface of the at least one optical fiber, forming a fiber-resin boundary, for at least a portion of the length of the optical fiber;
wherein the at least one optical fiber is attachable to a source of light energy so as to be in optical communication with the source of light energy, such that light energy from the source of light energy is communicated to and received by the at least one optical fiber and propagates along the at least one optical fiber when the source of light energy is activated;
wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the composite structure; while the remainder of the energy propagating along the at least one optical fiber is reflected back into the optical fiber and continues to propagate along the fiber until it again encounters the fiber-resin boundary.

2. The lighting apparatus of claim 1, wherein the at least one optical fiber is further defined as a plurality of optical fibers, each having an elongate shape having a longitudinal axis, each longitudinal axis of each of the optical fibers running in the same direction.

3. The lighting apparatus of claim 2, wherein the optical fibers of the plurality of optical fibers run in the same direction and are arranged to form a linear array when viewed in a cross-section taken transverse to the longitudinal axis of the plurality of optical fibers.

4. The lighting apparatus of claim 1, wherein the resin comprises a co-cure resin.

5. The lighting apparatus of claim 4, wherein the co-cure resin comprises a urethane component in a range of 25%-35% by weight.

6. The lighting apparatus of claim 1, wherein the at least one optical fiber is attached to the textile layer by weaving, using a binding thread, forming a woven illuminating layer.

7. The lighting apparatus of claim 1, wherein the intensity of the desired light energy escaping from the fiber-resin boundary is substantially uniform along the length of the optical fiber.

8. The lighting apparatus of claim 1, wherein cured resin remains tacky after curing, facilitating placement of the lighting apparatus in the laminating lay-up steps of a molding process.

9. A lighted object body structure, comprising:
an object body structure having an outer surface;
a lighting apparatus, comprising:
at least one optical fiber having a length and a longitudinal axis, and an outer surface;
wherein the at least one optical fiber is attached to a textile layer;
wherein textile layer and the at least one optical fiber are covered by a resin that has been cured, forming a lighting apparatus wherein the cured resin is in contact with at least a portion of the outer surface of the at least one optical fiber, forming a fiber-resin boundary, for at least a portion of the length of the optical fiber;
wherein, when the at least one optical fiber is attached to a source of light energy so as to be in optical communication with the source of light energy, light energy from the source of light energy is communicated to and received by the at least one optical fiber and propagates along the at least one optical fiber when the source of light energy is activated;
wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the object body structure; while a remainder of the energy propagating along the at least one optical fiber is reflected back into the optical fiber and continues to propagate along the fiber until it again encounters the fiber-resin boundary; and
wherein the lighting apparatus is disposed in the object body structure in proximity to an outer surface of the object body structure such that the light energy escaping the fiber-resin boundary is observable from outside the object body structure outer surface.

10. The lighted object body structure of claim 9, wherein the at least one optical fiber is further defined as a plurality of optical fibers, each having an elongate shape having a longitudinal axis, each longitudinal axis of each of the optical fibers running in the same direction.

11. The lighted object body structure of claim 10, wherein the optical fibers of the plurality of optical fibers run in the same direction and are arranged to form a linear array when viewed in a cross-section taken transverse to the longitudinal axis of the plurality of optical fibers.

12. The lighted object body structure of claim 9, wherein the resin is a co-cure resin.

13. The lighted object body structure of claim 12, wherein the co-cure resin comprises a urethane component in a range of 25%-35% by weight.

14. The lighted object body structure of claim 9, wherein the at least one optical fiber is attached to the textile layer by weaving, using a binding thread, forming a woven illuminating layer.

15. The lighted object body structure of claim 9, wherein the intensity of the desired light energy escaping from the fiber-resin boundary is substantially uniform along the length of the optical fiber.

16. The lighted object body structure of claim 9, where the object body structure is further defined as comprising composite materials.

17. The lighted object body structure of claim 16, where the object body structure is further defined as a laminated composite structure, produced using a mold.

18. The lighted object body structure of claim 9, where the cured resin remains tacky after curing, facilitating placement of the lighting apparatus in the laminating lay-up steps of a molding process.

19. The lighted object body structure of claim 9, wherein the composite structure forms a portion of a boat hull.

20. A method for producing a lighting apparatus, comprising the steps of:
providing a smooth molding surface;
applying a layer of clear gel coat to the smooth molding surface;
applying a first layer of resin to the clear gel coat;
applying a lighted fabric to the first layer of resin, the lighted fabric having a light emitting side, the light emitting side oriented against the first layer of resin;
applying a second layer of resin to the non-light emitting side of lighted fabric;
applying a layer of white gel coat to the second layer of resin to form a background layer; and
curing the layers of resin;
wherein the lighted fabric comprises:
at least one optical fiber having a length and a longitudinal axis, and an outer surface;
wherein the at least one optical fiber is attached to a textile layer;
wherein the textile layer and the at least one optical fiber are saturated by the first and second layers of resin prior to curing, and wherein the first and second layer cured resin is in contact with at least a portion of the outer surface of the at least one optical fiber, forming a fiber-resin boundary, for at least a portion of the length of the optical fiber;
wherein the at least one optical fiber is attachable to a source of light energy so as to be in optical communication with the source of light energy, such that light energy from the source of light energy is communicated to and received by the at least one optical fiber and propagates along the at least one optical fiber when the source of light energy is activated; and
wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the composite structure; while the remainder of the energy propagating along the at least one optical fiber is reflected back into the optical fiber and continues to propagate along the fiber until it again encounters the fiber-resin boundary.

21. The method of claim 20, wherein the at least one optical fiber is further defined as a plurality of optical fibers, each having an elongate shape having a longitudinal axis, each longitudinal axis of each of the optical fibers running in the same direction.

22. The method of claim 21, wherein the optical fibers of the plurality of optical fibers run in the same direction and are arranged to form a linear array when viewed in a cross-section taken transverse to the longitudinal axis of the plurality of optical fibers.

23. The method of claim 20, wherein the resin is a co-cure resin.

24. The method of claim 23, wherein the co-cure resin comprises urethane in a range of 24%-35% by weight.

25. The method of claim 20, wherein the at least one optical fiber is attached to the textile layer by weaving, using a binding thread, forming the woven illuminating layer.

26. The method of claim 20, wherein the intensity of the desired light energy escaping from the fiber-resin boundary is substantially uniform along the length of the optical fiber.

27. The method of claim 20, wherein cured resin remains tacky after curing, facilitating placement of the lighting apparatus in the laminating lay-up steps of a molding process.

28. A method for producing a lighted composite structure, comprising:
providing a smooth molding surface for molding a desired surface of a composite structure;
applying a layer of clear gel coat to the smooth molding surface;
applying a first layer of resin to the clear gel coat;
applying a lighted fabric to the layer of co-cure resin, the lighted fabric having a light emitting side, the light emitting side oriented against the first layer of resin;
applying a second layer of resin to the non-light emitting side of the lighted fabric;
applying one or more alternating structural fabric-resin layers to achieve a desired structural composite structure; and
curing the layers of resin;
wherein the lighted fabric comprises:
at least one optical fiber having a length and a longitudinal axis, and an outer surface;
wherein the at least one optical fiber is attached to a textile layer;
wherein the textile layer and the at least one optical fiber are saturated by the first and second layer of resin prior to curing, and wherein the first and second layer cured resin is in contact with at least a portion of the outer surface of the at least one optical fiber, forming a fiber-resin boundary, for at least a portion of the length of the optical fiber;
wherein the at least one optical fiber is attachable to a source of light energy so as to be in optical communication with the source of light energy, such that light energy from the source of light energy is communicated to and received by the at least one optical fiber and propagates along the at least one optical fiber when the source of light energy is activated; and
wherein an index of refraction of the cured resin is related to an index of refraction of the at least one optical fiber such that a desired portion of the light energy propagating along the at least one optical fiber escapes the at least one optical fiber when it encounters the fiber-resin boundary and is observable from outside the composite structure; while the remainder of the energy propagating along the at least one optical fiber is reflected back into the optical fiber and continues to propagate along the fiber until it again encounters the fiber-resin boundary.

29. The method of claim 28, wherein the at least one optical fiber is further defined as a plurality of optical fibers, each having an elongate shape having a longitudinal axis, each longitudinal axis of each of the optical fibers running in the same direction.

30. The method of claim 29, wherein the optical fibers of the plurality of optical fibers run in the same direction and are arranged to form a linear array when viewed in a cross-section taken transverse to the longitudinal axis of the plurality of optical fibers.

31. The method of claim 28, wherein the resin is a co-cure resin.

32. The method of claim 31, wherein the co-cure resin comprises a urethane component in a range of 25%-35% by weight.

33. The method of claim 28, wherein the at least one optical fiber is attached to the textile layer by weaving, using a binding thread, forming a woven illuminating layer.

34. The method of claim 28, wherein the intensity of the desired light energy escaping from the fiber-resin boundary is substantially uniform along the length of the optical fiber.
